(19) United States
(12) Patent Application Publication
(10) Pub. No.: US 2003/0002016 A1
(43) Pub. Date: Jan. 2, 2003

(54) Projecstor

(76) Inventors: Abigail Jane Sellen, Newbury (GB); Andrew Dudley Morgan, Bristol (GB)

Correspondence Address: HEWLETT-PACKARD COMPANY, Intellectual Property Administration, P.O. Box 272400, Fort Collins, CO, 80527-2400, US

(21) Appl. No.: 10/183,870

(22) Filed: Jun. 28, 2002

(30) Foreign Application Priority Data
Jun. 30, 2001 (GB) 0116115.7

(51) Int. Cl. G03B 21/00

(52) U.S. Cl. 353/31

(57) ABSTRACT

A digital image projector comprising projection means, a processor arranged to process digital images, and input means, the input means being electrically coupled to the processor and operable to supply digital images to the processor without the projector needing to be connected to a personal computer, and the processor being electrically coupled to the projection means to supply digital images to the projection means, the projector being configured to enable the image being projected to be rotated and/or translated to describe a trajectory around the surface on which the image is being projected.

This invention relates to a projector for displaying digital images.

Photography is a popular pastime, and digital photography, in which digital cameras capture photographs electronically without the need for photographic film, is increasingly gaining in popularity.

Enjoyment is to be gained by many users of digital photography from showing their family and friends photographs they have taken. Photographs intended for such exhibition might be photographs taken on holiday or at a family occasion such as a birthday party, or they might be amusing or embarrassing photographs of friends and family members which one would like to exhibit to others at a party. Some of the existing methods for showing digital photographs to others are for the audience to gather around a personal computer (PC) to which the photographs have been downloaded from a digital camera, or for the photographs to be printed onto paper and then passed around the intended audience. However, if the audience comprises many people, gathering around a PC can be awkward, and passing photographs around can be time consuming. To hasten the latter procedure multiple prints could be made, but this is then costly since the photographer would first be obliged to own (or at least have access to) a suitable printer and would then be required to print out a number of identical pictures, thereby consuming resources of paper and printer ink. Alternatively the photographer's digital camera itself could be passed around the audience, but this method is also time consuming, is potentially risky since the camera could get lost, stolen or damaged (particularly by someone unfamiliar with its operation) and does not readily enable the photographer to explain the photographs as they are viewed.

There is accordingly a need for an alternative procedure by which digital photographs can readily be exhibited to an audience.

At home, and particularly when holding a party, people often desire an interesting yet impermanent means to decorate a room. There is particularly a desire for a means to provide an ambient dynamic display of patterns and images around a room without first having to buy and install expensive lighting equipment.

A young infant in a cot or on a playpen requires a great deal of amusement, comforting and attention. It is common for parents to provide the infant with toys, some of which (particularly for very young babies) may be arranged to hang over the cot such that they provide an amusing distraction for the infant without the child being able to reach them. Arranging the toy to be out of reach of the child ensures that it does not present a potential health hazard (e.g. a risk of choking) to the baby. Examples of such non-contact toys are hanging mobiles and projectors, such as the Tomy (RTM) ‘Lullaby Light Show’ which projects a revolving display of characters onto the ceiling or walls above the baby's cot. However, it is well known and recommended by advisers on parenting techniques that there is no substitute for the baby seeing its parents on a regular basis during the first few months of its life. A projector which displays impersonal characters to the baby, whilst providing an amusing distraction, cannot provide the comfort to the baby of seeing its parents.

Unfortunately a baby's parents are often unable to give their child the personal attention it ideally requires early in life. For parents who are sometimes unable to be with their child, there clearly exists a need for an alternative means by which the baby can see and be comforted by its parents when the parents are unable to attend in person.

It is accordingly a general object of the present invention to overcome or at least mitigate the problems identified above.

According to the present invention there is provided a digital image projector comprising projection means, a processor arranged to process digital images, and input means, the input means being electrically coupled to the processor and operable to supply digital images to the processor without the projector needing to be connected to a personal computer, and the processor being electrically coupled to the projection means to supply digital images to the projection means, the projector being configured to enable the image being projected to be rotated and/or translated to describe a trajectory around the surface on which the image is being projected. This has the advantage that digital photographs can readily be projected before an audience, without the user needing to own or have access to a personal computer. As a further consequence, the photographs do not need to be printed onto paper and passed around the audience, thereby saving time and the cost of printing photographs. By enabling the projected image to be moved around advantageously enables an interesting ambient display to be provided at a party or for the entertainment of a young child.

Preferably the projection means comprises a liquid crystal matrix and a light source.

Preferably the input means comprises a port arranged to receive a solid state memory module on which digital image data is stored. This has the advantage of enabling a user to insert into the projector a solid state memory module on which digital photographs have been stored using another piece of equipment such as a digital camera. The projector is then able to project these images to the audience.

Particularly preferably the solid state memory module is a Compact Flash card, a Memory Stick, or a Smart Media card. Advantageously these are established portable media on which digital photographs can be stored, particularly by digital cameras.

Preferably the projection means may be adjustably angled such that, with the projection means in a first position, digital images may be projected onto a wall, and with the projection means in a second position, digital images may be projected onto a ceiling. This has the advantage of enabling photographs to be projected onto a wall for exhibition to an audience in a conventional manner, and also enables photographs or other images to be projected onto a ceiling to provide an ambient display for use at a party or to entertain or comfort a young child.

Preferably the rotation and/or translation of the image is performed electronically by the processor, thereby enabling the image to be moved without the projector needing to have moving parts to achieve this. Alternatively, the projector further comprises mechanical means operable to rotate and/or translate the projection means. These mechanical means are, for example, electrically powered motors arranged to translate the projection means or the lens, thereby causing the projected image to move around.

Preferably the projector further comprises a turntable attached to an exterior surface of the projector, the turntable being adapted for placing on a substantially horizontal surface and configured to enable the projector to be rotated using the turntable. This advantageously provides a straightforward and effective way of providing a rotating projected image (e.g. around the walls of a room or on a ceiling), thereby giving an interesting ambient display.

Preferably the processor is configured to enable image correction algorithms to be applied to the image being projected, thereby enabling the image being projected to be compensated for any distortion arising from the projection means not facing normal to the surface on which the image is being projected, and thereby resulting in a projected image that is substantially free of distortion. This advantageously results in substantially undistorted images even though the projector might not be aligned normal to the surface on which the image is being projected. To achieve this, more preferably the projector further comprises a user interface operable to enable the input of information to the processor, the information input to the processor being interpreted by the processor to determine the appropriate image correction algorithms which are applied to the image in order to result in a projected image that is substantially free of distortion. The user interface preferably comprises buttons analogous to the adjustment controls of a computer monitor or the tracking controls of a domestic video cassette recorder, and the information supplied by the user using this user interface is interpreted by the processor to adjust the image to compensate the image to counter distortion that would otherwise result. Alternatively, the projector further comprises a wireless transmitter and receiver (particularly preferably which operate using ultrasound) operable to measure the distance from the projector to the surfaces on which the image is projected, thereby enabling the processor to determine appropriate image correction algorithms which are applied to the image in order to result in a projected image that is substantially free of distortion. This has the advantage that the projector itself determines the necessary adjustments to be made to the image in order to mitigate distortion, without any input being necessary from the user.

Preferably the processor is configured to enable it to be updated with information to enable it to recognise and interpret a plurality of image file formats. Such file format update information may be supplied on solid state memory modules which are inserted into the projector in the same manner as for solid state memory modules containing photographic data, or alternatively the update information may be transferred to the projector via a connection to a personal computer or the Internet. The connection means may be electrical (e.g. using a serial or USB cable) or wireless (e.g. using infra red or radio frequency (e.g. Bluetooth (RTM)) transmission). The processor is configured to update itself using this information, thereby advantageously enabling it to be able to interpret new image file formats when they are devised.

Preferably the projector further comprises audio input means by which audio signals can be supplied to the processor, the processor being electrically coupled to the said audio input means and configured to alter the projected image in response to the said audio signals. Particularly preferably the audio input means comprises a microphone or audio input jacks. This facility advantageously enables the projector to respond to audio signals, in particular, to music, and to vary the projected images in time with the beats of the music. This adds functionality to the projector for use in the provision of ambient images at parties.

Embodiments of the invention will now be described, by way of example, and with reference to the drawings in which:

FIG. 1 illustrates a digital image projector arranged to project images onto a wall;

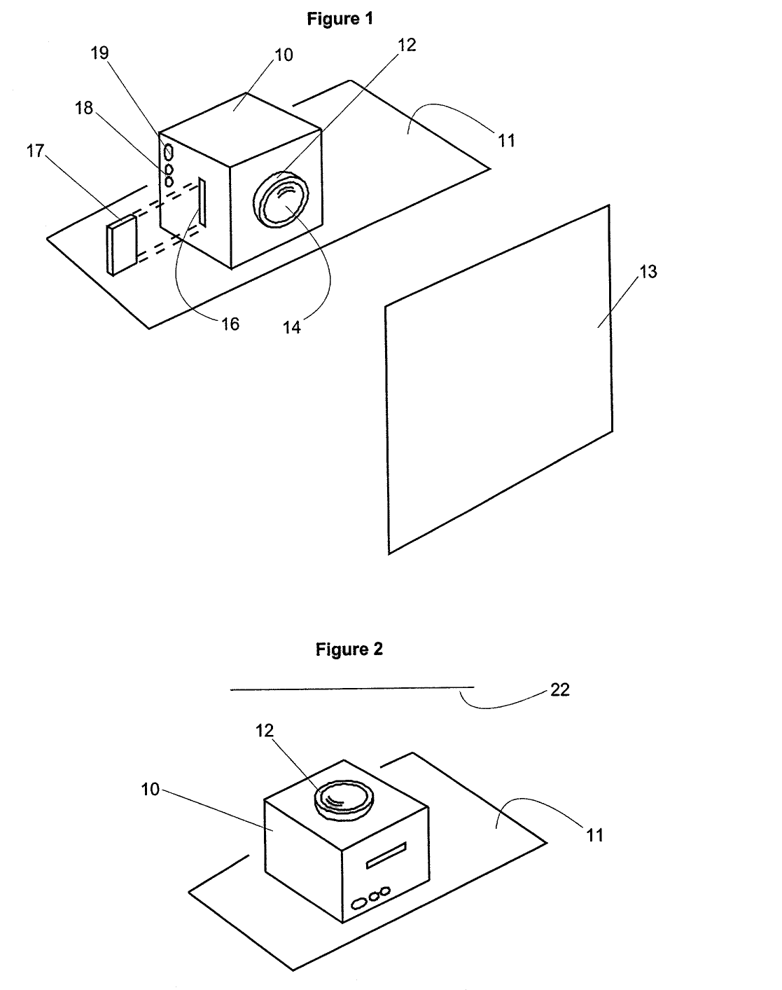

FIG. 2 illustrates the digital image projector of FIG. 1 arranged to project images onto a ceiling;

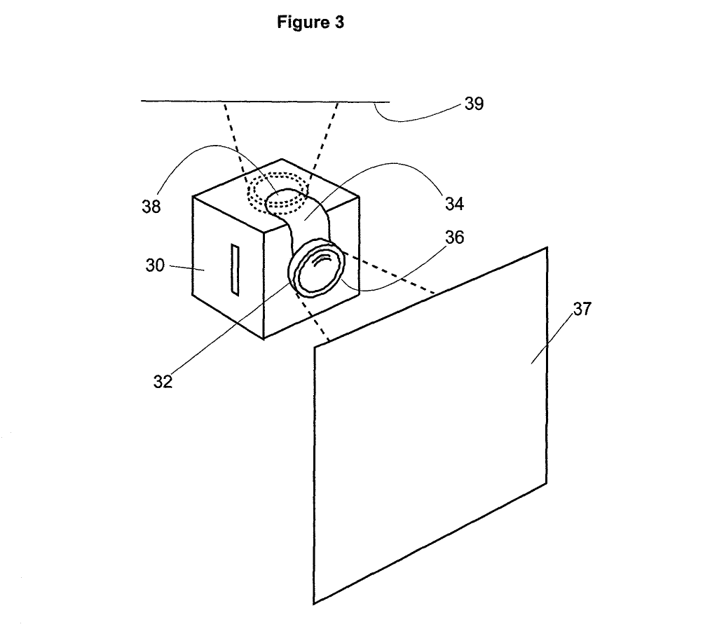

FIG. 3 illustrates a digital image projector in which the projection means may be adjustably angled between a first position and a second position.

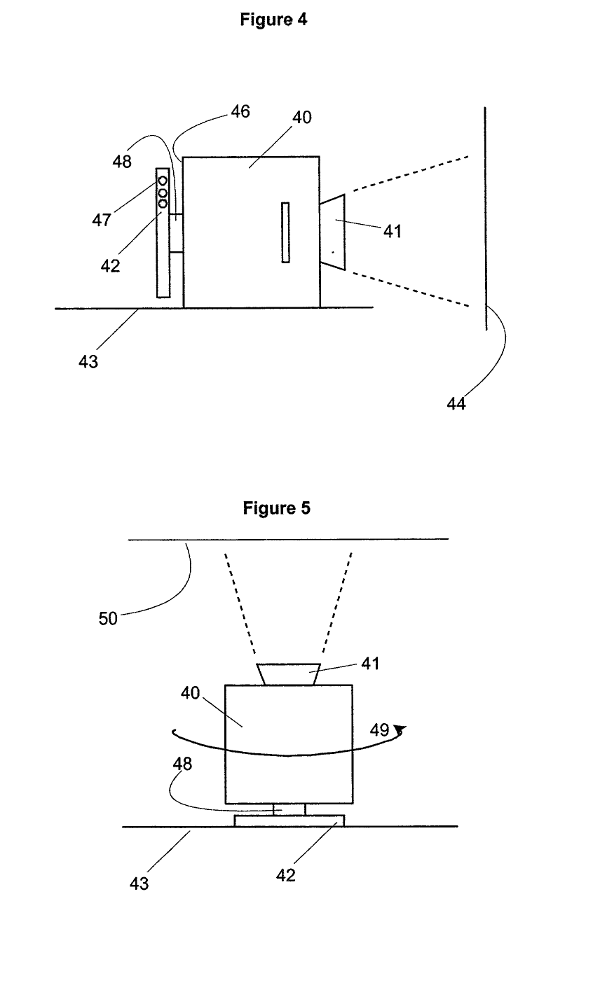

FIG. 4 illustrates a digital image projector having a turntable, arranged to project images onto a wall;

FIG. 5 illustrates the digital image projector of FIG. 4 arranged to project images onto a ceiling and to rotate these images;

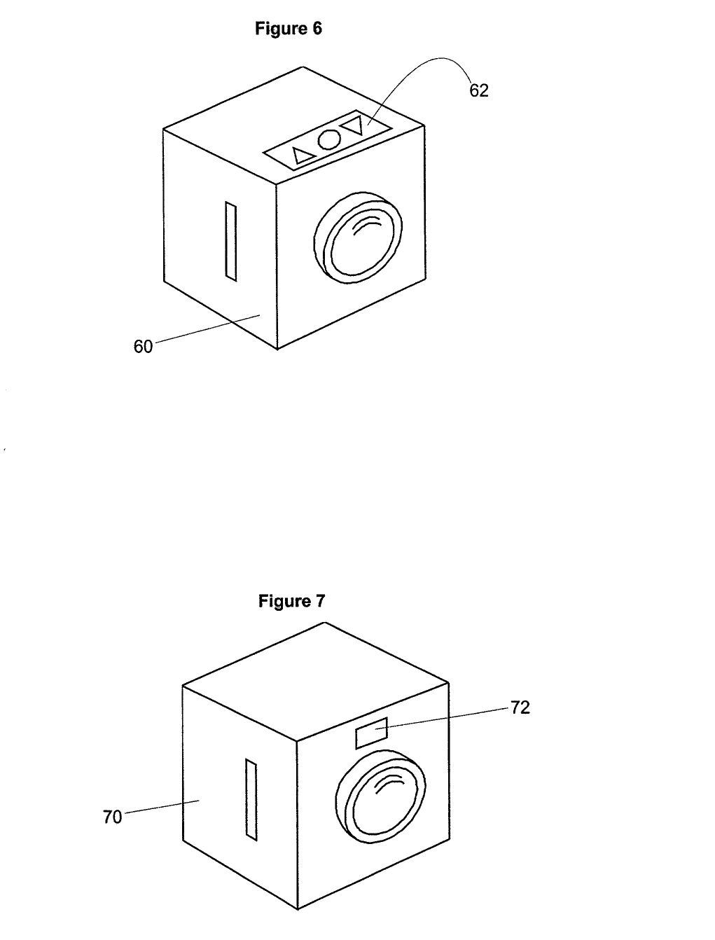

FIG. 6 illustrates a digital image projector having a user interface comprising buttons;

FIG. 7 illustrates a digital image projector having an ultrasound transmitter and receiver;

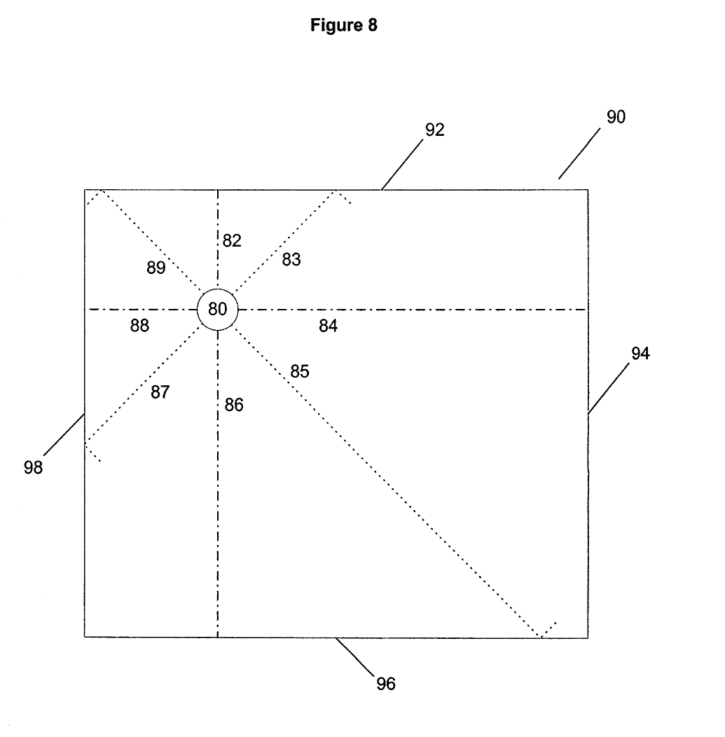

FIG. 8 illustrates the use of ultrasonic signals by the projector to determine its position in a room (shown schematically in plan view); and

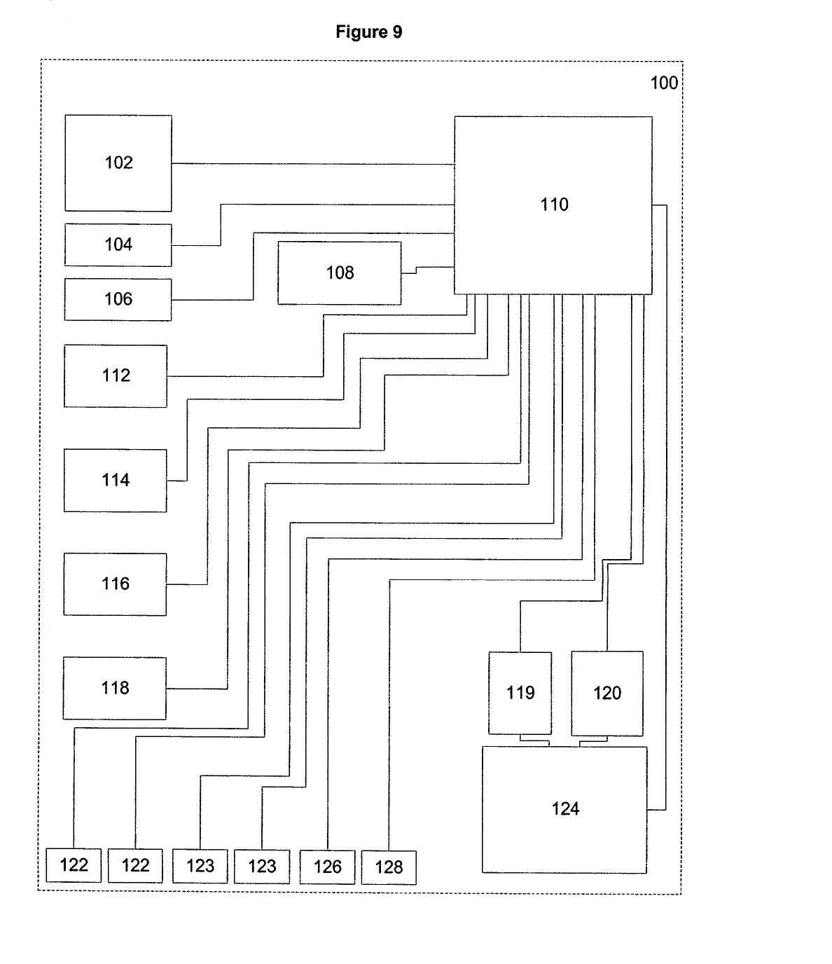

FIG. 9 illustrates the electronic architecture of a digital image projector.

As illustrated in FIG. 1, a digital image projector 10 comprises a digital projection means 12 which has a lens 14 through which the digital image is projected towards a surface such as a wall 13 or a projection screen. In order for the projector to be reasonably priced, the projection means preferably comprise a liquid crystal matrix and a light source such as a lamp. Internally the projector further comprises a processor arranged to process the digital images, electrically coupled to a port 16 into which a solid state memory module 17 can be slotted and electrically coupled. Solid state memory modules are known in the field of digital photography, and digital cameras are often configured to store their photographs onto such modules which can be plugged into the camera. Examples of such solid state memory modules are Compact Flash cards, a Memory Sticks and Smart Media cards, all of which can store a plurality of digital photographs. The processor is able to cause the projection of specific photographs selected by the user, or to project a number of photographs in a cyclic or random sequence, and can manipulate the images in a variety of ways as will be described below.

It is highly advantageous for the projector to be able to receive and to work with media modules which are also compatible with the user's digital camera, since this provides a straightforward method of displaying photographs: The user takes the photographs, then removes the solid state memory module from the camera, inserts it into the projector, and projects the photographs before the intended audience.

The projector of FIG. 1 is designed to project towards a wall or a ceiling. As illustrated in FIG. 2, the projector of FIG. 1 can been placed on a substantially horizontal surface 11 such that the projection means 12 faces vertically upwards to enable images to be projected onto a ceiling 22.

A single projector can be used to project images onto both walls or ceilings, according to the user's preference. Projection onto walls would generally be undertaken when displaying photographs (e.g. of places visited on holiday) before an audience. However, the user may well wish to project images onto a ceiling instead. In this case, the images might be of an abstract nature, rather than being conventional photographs, to provide ambient room decoration at a party, for example. Alternatively images may be projected onto the ceiling above a baby's cot, in order to entertain or comfort the child. These images may advantageously be of the child's parents, to further comfort the child and to increase its familiarity with its parents.

In order to better enable the provision of ambient images at parties, the projector may incorporate means to enable the processor to respond to ambient sound (music in particular) and to vary the projected image accordingly. For example, a microphone 19 may be incorporated in the body of the projector, or audio input jacks 18 may be provided to enable the projector to be connected to a music system, e.g. using a pair of phono leads. The microphone and audio input jacks are electrically connected to the processor and, on instruction by the user, the processor is configured to interpret the audio signals, to identify the beats and rhythmic characteristics of the music, and to respond to the music being played—for example, by varying the projected image in time with the music. The algorithms that would be employed by the processor to alter the projected image are known to those skilled in the art. For example, the Microsoft (RTM) Media Player 7.1 incorporates transformation algorithms which can analyse audio waveforms and provide abstract visualisations on the computer's visual display. This feature of the projector may be employed with it projecting onto a wall or a ceiling, according to the user's preference at the time.

Instead of the user having to move the entire projector when changing the projection direction (e.g. from horizontal to vertical), the projector may optionally incorporate adjustable projection means as shown in FIG. 3. In this embodiment of the invention the projection means 32 can be adjustably angled between a first position 36 and a second position 38. With the projection means 32 in the first position 36, digital images may be projected onto a wall 37. However, by the user moving the projection means 32 into the second position 38, using the guide 34, digital images may be projected onto a ceiling 39. Movement between the first and second positions may be effected manually or by the operation of a motor controlled by the processor.

To provide enhanced ambient imagery at parties and other social occasions, it is desirable for the projector to move and rotate the projected image. Accordingly, in the preferred embodiment of the invention, the projector is configured to enable the image being projected to be translated to describe a trajectory around the wall or ceiling as desired, and/or to rotate the image. This translation and/or rotation may be achieved electronically, by the processor moving or rotating the image within the possible projection area of the projector. That is to say, the image that is projected is smaller than the total projection area of which the projector is capable, and the image is electronically moved and/or rotated within this area.

Alternatively, enabling the projection of translating or rotating images which utilise the full possible projection area of the projector, the projector may comprise mechanical means operable to translate and/or rotate the projection means itself. These mechanical means are, for example, motors arranged to move and/or rotate the projection means, in order to cause the projected image to move around.

An alternative means to enable rotation of the projected image involves equipping the projector with a turntable, as illustrated in FIGS. 4 and 5. The turntable 42 is mechanically attached to an exterior surface 46 of the body of the projector 40, preferably via a motorised spindle 48. When being used to provide a simple exhibition of static photographs against a wall 44, the projector is arranged as shown in FIG. 4 and the turntable is not employed. However, when the user desires rotating images to be projected on a ceiling 50, the projector is placed on a floor 43 (or another broadly horizontal surface) such that the turntable 42 lies against the floor. On activating the motorised spindle 48 the turntable itself does not rotate, but the body of the projector 40 rotates with the projection means facing vertically upwards, thereby providing a rotating image on the ceiling 50.

The turntable 42 can be made to be detachable by the user from the body of the projector 40.

It will be appreciated that the turntable feature of FIGS. 4 and 5 may be readily combined with the angularly-adjustable projection means of FIG. 3, thereby giving a projector which may either project a rotating image onto the ceiling or may sweep an image around the walls of a room by using the rotating turntable against the floor and the projection means angled towards the walls. Moreover, if the angularly-adjustable projection means of FIG. 3 is motorised then, using the turntable, the projector can project a image which sweeps around the walls and also the ceiling. In such a case, the processor may be configured to vary the angle of projection whilst the projector is simultaneously rotated by the turntable.

It will be appreciated that the apparatus must be designed such that, when the projector is physically rotated by the turntable, any power supply or audio cables do not become tangled around the projector as it rotates. This potential problem can be overcome by providing the electrical connection ports 47 (e.g. audio input jacks 26) in the edge of the turntable 42. Electrical connections pass through the inside of the rotating spindle 48 and through to the body of the projector 40, using known techniques (e.g. electrical bushes) such that the electrical connections are maintained as the projector rotates.

The projector of the present invention is intended to be readily usable without the need for a dedicated stand or careful alignment. As a consequence, it will be appreciated that the projected image could potentially suffer from distortion should the projection means not be facing normal to the surface (e.g. the wall) on which the image is being projected. This is particularly relevant during the projection of images across the walls of a room whilst the projector simultaneously rotates. To overcome this problem of image distortion, the processor is preferably configured to enable image correction algorithms and transformation functions to be applied to the image being projected, thereby compensating the image such that the projected image as viewed is substantially free of distortion.

In order to determine the appropriate image correction algorithm to employ, the processor must be provided with information pertaining to the geometry of the room and the distortion to be compensated.

Accordingly, as illustrated in FIG. 6, the projector 60 may comprise a user interface 62 which typically consists of a series of buttons. These buttons, which are analogous to the adjustment controls of a computer monitor or the tracking controls of a domestic video cassette recorder, are operable by the user. By using these controls, the user supplies information to the processor vis-à-vis the degree of distortion of the image, and this information is interpreted by the processor to determine the appropriate transformation functions which are then applied to the image. The image is adjusted in real time as the user presses the buttons, to result in a viewed image that is substantially free of distortion. This user-controlled technique is particularly well suited to adjusting a stationary projected image to compensate it against distortion.

The manual image compensation technique described above does not lend itself well to compensating an image that is moving around the walls of a room. This problem may be overcome using an alternative embodiment of the projector in which, as shown in FIG. 7, the projector 70 further comprises a wireless transmitter and receiver 72 aligned with the lens of the projector. The wireless transmitter and receiver preferably operate using ultrasound, transmitting and receiving signals parallel to the direction of image projection. By measuring the time of flight of these signals and the relative intensity of each received signal in comparison to the transmitted signal the processor is able to map the room and thereby determine the appropriate correction algorithms and transformations to be applied to the image in order to result in a projected image that is substantially free of distortion. This technique has the advantage that the projector itself determines the necessary adjustments to be made to the image in order to mitigate distortion, without any input being necessary from the user.

This technique of ultrasonic mapping in order to compensate the projected images requires the projector to be rotated through 360° at least once prior to commencing projection. Consequently, the projector preferably incorporates a motorised turntable as indicated in FIGS. 4 and 5, and also means for adjusting the angle of projection as illustrated in FIG. 3. For performing ultrasonic mapping of walls, the optimal configuration of the projector is with the lens and ultrasound device oriented horizontally and the turntable configured to rotate the projector through 360° such that the ultrasonic signal is swept around the walls of the room. As shown schematically in FIG. 8, a number of ultrasonic pulses 82-89 are transmitted periodically from the projector 80 during its rotation. For each transmitted pulse, the ultrasonic receiver device detects any reflected signal, measuring the intensity of the received pulse and also determining its time of flight. This intensity data is recorded with respect to the angle through which the projector has rotated, and is then interpreted by the processor. In so doing, the processor uses an algorithm based on the assumption that the projector 80 is in a rectangular room 90 having four planar walls 92,94,96,98 and a ceiling perpendicular to the walls. During the 360° of rotation, the processor identifies the four strongest reflected signals 82,84,86,88 which are directly reflected perpendicularly from the four walls 92,94,96,98. By analysing the time of flight of these signals 82,84,86,88 the processor also calculates the distance of each of the corresponding four walls 92,94,96,98 from the projector. Signals 83,85,87,89 which are not reflected straight back are either lost and consequently undetected, or undergo multiple reflections and are detected but at significantly reduced intensity such that the processor effectively disregards them.

The distance from the projector to the ceiling can also readily be determined by the projector by adjusting the angle of the projection means such that it faces up towards the ceiling. This reorientation of the projection means may be performed automatically as part of the mapping process described above if the angularly-adjustable projection means is motorised and the motor is controlled by the processor. Ultrasonic time of flight measurements are performed to determine the distance to the ceiling. In case the projector is not oriented normal to the ceiling, the processor may also perform a rotational ultrasonic scan through 360° against the ceiling, and by interpreting the intensity of the received signals the processor can determine any misalignment of the projector with respect to the ceiling.

The distance of the projector from each of the four walls and the ceiling is then used by the processor to digitally manipulate the image during subsequent projection whilst the projector rotates: The processor causes the image to be projected in a conventional manner, without compensation, when the projector is facing normal to one of the walls or the ceiling. However, when the projector has rotated such that it is no longer facing normal to a projection surface, the processor uses the geometry of the room with respect to the projector and the angle through which the projector has rotated in order to determine the necessary adjustment to be made digitally to the image in order to compensate it against distortion. That is to say, the image as generated by the projection means is adjusted such that the image that is actually viewed on the projection surface is substantially (as far as possible) undistorted. This image adjustment is performed digitally using appropriate geometric transformations known to those skilled in the art. The transformations would typically be image warping such as perspective projection corrections (e.g. non-linear stretching or compression of the image along one or two axes).

The use of ultrasonic pulses also enables the projector to automatically focus on the projection surface. By determining the distance from the projector to the projection surface, and by employing techniques known to those skilled in projector construction, the processor can be configured to adjust the lens of the projector to provide an image of optimal focus.

As users of computer equipment are aware, a variety of image file formats exist, and new ones are introduced from time to time. Highly advantageously, the processor is configured be able to be updated with information to enable it to recognise and interpret new image file formats when they are devised. Such file format update information may be supplied on solid state memory modules which are inserted into the projector in the same manner as for solid state memory modules containing photographic data, or alternatively the update information may be transferred to the projector via a connection to a personal computer or the Internet. The connection means may be electrical (e.g. using a serial or USB cable) or wireless (e.g. using infra red or radio frequency (e.g. Bluetooth (RTM)) transmission).

Additional Optional Features of the Projector

A projector constructed in accordance with the present invention may optionally be configured to handle moving images, and optionally sound via the incorporation of a built-in speaker or audio output jacks to enable the projector to be connected to a sound system. These moving images could be short video clips taken by a digital camera, or a longer video film recorded using a video camera or supplied as a pre-recorded commercially-produced movie.

Electronic Architecture of the Projector

As shown schematically in FIG. 9, the electronic architecture of a projector 100 constructed in accordance with the present invention comprises a processor 110 electrically connected to projection means 102, which preferably comprise a liquid crystal matrix and a light source. The processor 110 is also connected to a solid state memory port 112 arranged to accept and electrically couple with a solid state memory module such as flash card, and to a power supply 124 such as a battery or an ac mains transformer. The power supply 124 provides electrical power, either directly or via the processor 110, to the electronic and electrical components within the projector.

The processor 110 is connected to built-in memory 108 which enables the ‘hot-swapping’ of flash cards. Hot-swapping is a process by which flash cards can be inserted and removed whilst the projector remains electrically operational, and enables a picture to remain displayed when the flash card is removed.

Also connected to the processor 110 are a user interface 104 comprising buttons (or alternatively a touch panel) to enable the user to input instructions to the processor 110 and an ultrasound transmitter and receiver 106 to enable the projector to map the position of the walls or ceiling. The user interface 104 enables the user to adjust the projected image to compensate for distortion, as described previously, and also provides appropriate buttons and controls for the general control of the projector, including an on/off switch and controls to enable the user to activate or deactivate the turntable (and to set its speed of rotation). Controls are also provided to cause the processor to display a single image, or an array of ‘thumbnail’ images from which the user can select a desired image for projection, or a number of images in a predetermined sequence (either proceeding automatically through the sequence or waiting to receive input from the user before advancing). Additionally the user interface 104 includes means to cause the processor to generate (and display using the projection means) a menu of further options relating to the configuration of the projector. These further options include setting the desired rotation and translation effects to be applied to the images, and also determining how the projection should respond to ambient sound or music.

Further connected to the processor 110 are an electrical cable connection 114 to enable the projector to be connected to a personal computer, an infra-red transmitter and receiver 116, and a radio frequency (Bluetooth (RTM)) transmitter and receiver 118. It will be appreciated that none of these connectivity features are essential for the projector to be able to operate in accordance with the present invention, but they are desirable in order to allow the device to communicate with other electronic devices such as PCs or portable data assistants.

To enable the projector to be connected to a music system in order to provide dynamic ambient images that respond in time with music, the processor 110 is connected to a pair of audio input jacks 122 and a microphone 126.

To enable the projector to play images (e.g. movies) which are accompanied by prerecorded sound, the processor is also connected to audio output jacks 123 and a built-in speaker 128.

The processor 110 and the power supply 124 are also connected to an electric motor 119 to operate a turntable, and additional electric motors 120 to translate, rotate and adjust the angle of the projection means, all of which enable the projector to provide an interesting display of moving and rotating ambient imagery.

1. A digital image projector comprising projection means, a processor arranged to process digital images, and input means, the input means being electrically coupled to the processor and operable to supply digital images to the processor without the projector needing to be connected to a personal computer, and the processor being electrically coupled to the projection means to supply digital images to the projection means, the projector being configured to enable the image being projected to be rotated and/or translated to describe a trajectory around the surface on which the image is being projected.

2. A digital image projector as claimed in claim 1 wherein the projection means comprises a liquid crystal matrix and a light source.

3. A digital image projector as claimed in claim 1 or claim 2 wherein the input means comprises a port arranged to receive a solid state memory module on which digital image data is stored.

4. A digital image projector as claimed in claim 3 wherein the solid state memory module is a Compact Flash card.

5. A digital image projector as claimed in claim 3 wherein the solid state memory module is a Memory Stick.

6. A digital image projector as claimed in claim 3 wherein the solid state memory module is a Smart Media card.

7. A digital image projector as claimed in any preceding claim wherein the projection means may be adjustably angled such that, with the projection means in a first position, digital images may be projected onto a wall, and with the projection means in a second position, digital images may be projected onto a ceiling.

8. A digital image projector as claimed in any preceding claim wherein the rotation and/or translation of the image is performed electronically by the processor.

9. A digital image projector as claimed in any of claims 1 to 7 wherein the projector further comprises mechanical means operable to rotate and/or translate the projection means.

10. A digital image projector as claimed in claim 9 wherein the projector further comprises a turntable attached to an exterior surface of the projector, the turntable being adapted for placing on a substantially horizontal surface and configured to enable the projector to be rotated using the turntable.

11. A digital image projector as claimed in any preceding claim wherein the processor is configured to enable image correction algorithms to be applied to the image being projected, thereby enabling the image being projected to be compensated for any distortion arising from the projection means not facing normal to the surface on which the image is being projected, and thereby resulting in a projected image that is substantially free of distortion.

12. A digital image projector as claimed in claim 11 wherein the projector further comprises a user interface operable to enable the input of information to the processor, the information input to the processor being interpreted by the processor to determine the appropriate image correction algorithms which are applied to the image in order to result in a projected image that is substantially free of distortion.

13. A digital image projector as claimed in claim 11 wherein the projector further comprises a wireless transmitter and receiver operable to measure the distance from the projector to the surfaces on which the image is projected, thereby enabling the processor to determine appropriate image correction algorithms which are applied to the image in order to result in a projected image that is substantially free of distortion.

14. A digital image projector as claimed in claim 13 wherein the wireless transmitter and receiver operate using ultrasound.

15. A digital image projector as claimed in any preceding claim wherein the processor is configured to enable it to be updated with information to enable it to recognise and interpret a plurality of image file formats.

16. A digital image projector as claimed in any preceding claim wherein the projector further comprises audio input means by which audio signals can be supplied to the processor, the processor being electrically coupled to the said audio input means and configured to alter the projected image in response to the said audio signals.

17. A digital image projector as claimed in claim 16 wherein the audio input means comprises a microphone.

18. A digital image projector as claimed in claim 16 wherein the audio input means comprises audio input jacks.

19. A digital image projector substantially as hereinbefore described with reference to the accompanying drawings.
